(19) United States
(12) Patent Application Publication
(10) Pub. No.: US 2025/0083566 A1
(43) Pub. Date: Mar. 13, 2025

(54) BALANCING CONTROL SYSTEM AND BALANCING CONTROL METHOD FOR VEHICLE BATTERY MODULE

(71) Applicants: HYUNDAI MOTOR COMPANY, SEOUL (KR); KIA CORPORATION, SEOUL (KR)

(72) Inventors: Sung Min Hong, Hwaseong-si (KR); Yong Gyu Lee, Hwaseong-si (KR)

(73) Assignees: HYUNDAI MOTOR COMPANY, SEOUL (KR); KIA CORPORATION, SEOUL (KR)

(21) Appl. No.: 18/825,540

(22) Filed: Sep. 5, 2024

(30) Foreign Application Priority Data
Sep. 7, 2023 (KR) 10-2023-0119163
Aug. 28, 2024 (KR) 10-2024-0115691

(51) Int. Cl. B60L 58/22; B60L 58/12; H02J 7/00

(52) U.S. Cl. CPC B60L 58/22; B60L 58/12; H02J 7/0014; B60L 2210/10; B60L 2210/40

(57) ABSTRACT

A balancing control system for a battery module includes a plurality of battery modules each including a battery outputting a battery voltage, a first DC/DC converter connected to the battery in parallel, and an inverter converting the battery voltage into an AC module voltage and outputting the same, and a controller controlling each of the plurality of battery modules. First DC/DC converters included in the plurality of battery modules are connected to each other in parallel, and the controller is configured to monitor a battery state including at least one of a state-of-charge (SoC) of the battery or the battery voltage, and to control the first DC/DC converter to have an ON state or an OFF state based on the battery state.

### CROSS REFERENCE TO RELATED APPLICATIONS

This application claims benefit of priority to Korean Patent Application No. 10-2023-0119163 filed on Sep. 7, 2023 and Korean Patent Application No. 10-2024-0115691 filed on Aug. 28, 2024 in the Korean Intellectual Property Office, the disclosure of which is incorporated herein by reference in its entirety.

### BACKGROUND

### 1. Field

The present disclosure relates to a balancing control system and a balancing control method, for a battery module for a vehicle.

### 2. Description of Related Art

In recent times, as interest in issues such as energy efficiency, environmental pollution, fossil fuel depletion, or the like has increased, the development of eco-friendly vehicles that may be practically replaced with internal combustion engine vehicles is actively being undertaken.

Such eco-friendly vehicles may include battery electric vehicles (BEVs) using batteries as a power source (electric power source), fuel cell electric vehicles (FCEVs) using fuel cells as a main power source, hybrid electric vehicles (HEVs) using engines and motors together as a driving device to drive the vehicle, and the like.

The above-mentioned eco-friendly vehicles may be called electric vehicles (xEVs) in a broad sense, and have in common that they may be motor-driven vehicles and electrified vehicles that drive motors with power from a high-voltage power source such as a battery or a fuel cell.

Meanwhile, a high-voltage battery pack formed of a plurality of battery cells may generate a difference in deterioration between the battery cells depending on battery use, to have a difference in performance. At this time, a difference in internal resistance may occur due to a difference in performance between the battery cells, and a difference in voltage may occur between cells during charging/discharging. When a difference in voltage occurs between cells in this manner, a charging time of the battery may increase, and a driving time or a distance may be shortened.

### SUMMARY

An aspect of the present disclosure is to increase battery charging/discharging efficiency by performing balancing control of maintaining deviation of a state-of-charge (SoC) between a plurality of battery modules configured in a series/parallel combination of the plurality of battery modules operating at a low voltage within a certain range.

In addition, an aspect of the present disclosure is to perform active balancing control by controlling on/off switching of a converter included in each battery module for balancing control.

The purpose of the present disclosure is not limited to tasks mentioned above, and other tasks not mentioned will be clearly understood by those with ordinary knowledge from the description below.

In order to achieve the above-mentioned purpose, the present disclosure provides a balancing control system and a balancing control method, for a battery module, as follows.

According to an aspect of the present disclosure, a balancing control system for a battery module includes a plurality of battery modules respectively including a battery outputting a battery voltage, a first DC/DC converter connected to the battery in parallel, and an inverter converting the battery voltage into an AC module voltage and outputting the same; and a controller controlling each of the plurality of battery modules, wherein first DC/DC converters included in the plurality of battery modules are connected to each other in parallel, and the controller is configured to monitor a battery state including at least one of a state-of-charge (SoC) of the battery or the battery voltage, and to control the first DC/DC converter to have an ON state or an OFF state, based on the battery state.

According to another aspect of the present disclosure, a balancing control method for a plurality of battery modules respectively including a battery, a first DC/DC converter connected to the battery in parallel, and an inverter includes monitoring a state-of-charge (SoC) of the battery included in each of the plurality of battery modules, and controlling the first DC/DC converter to have an ON state or an OFF state based on the SoC.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 illustrates an electric vehicle drive system including a general high-voltage battery pack.

FIGS. 2 and 3 illustrate a battery module according to an embodiment of the present disclosure.

FIG. 4 is a view illustrating a connection structure between a plurality of battery modules according to an embodiment of the present disclosure.

FIG. 5 illustrates a single-phase battery system according to an embodiment of the present disclosure.

FIG. 6 is a view illustrating a connection relationship of an inverter in a three-phase battery system according to an embodiment of the present disclosure.

FIG. 7 is a view illustrating a connection relationship of a first DC/DC converter in a three-phase battery system according to an embodiment of the present disclosure.

FIG. 8 is a view illustrating a connection relationship of a second DC/DC converter in a three-phase battery system according to an embodiment of the present disclosure.

FIG. 9 is a view illustrating an inverter structure according to an embodiment of the present disclosure.

FIG. 10 is a flowchart of a balancing control method of a battery module according to an embodiment of the present disclosure.

FIG. 11 is a flowchart of a balancing control method of a battery module according to an embodiment of the present disclosure.

FIG. 12 is a block diagram of a computing device that may fully or partially implement a battery module balancing control system according to an embodiment of the present disclosure.

### DETAILED DESCRIPTION

Hereinafter, specific embodiments of the present disclosure will be described with reference to the accompanying drawings. The following detailed description is provided to aid in a comprehensive understanding of a method, a device and/or a system described in the present specification. However, the detailed description is for illustrative purposes only, and the present disclosure is not limited thereto.

In describing the embodiments of the present disclosure, when it is determined that a detailed description of a known technology related to the present disclosure may unnecessarily obscure the gist of the present disclosure, a detailed description thereof will be omitted. In addition, terms to be described later are terms defined in consideration of functions in the present disclosure, which may vary depending on intention or custom of a user or operator. Therefore, the definition of these terms should be made based on the contents throughout the present specification. The terminology used herein is for the purpose of describing particular embodiments only and is not to be limiting of the embodiments. As used herein, the singular forms are intended to include the plural forms as well, unless the context clearly indicates otherwise. As used herein, the terms “comprise,” “include,” “have,” or the like, when used in the present specification, specify the presence of stated features, integers, steps, operations, elements, components or a combination thereof, but do not preclude the presence or addition of one or more other features, integers, steps, operations, elements, components, and/or groups thereof.

In addition, as described below, a ‘module voltage’ may mean a voltage output from a battery module, and a ‘system voltage’ may mean a voltage output from a battery system configured based on the battery module.

The battery module described below may include a battery module for a vehicle, and the battery system may include a single-phase battery system for a vehicle and a three-phase battery system for a vehicle, or a battery module balancing control system.

In addition, the present disclosure may be used in various devices to which a battery module and a battery system are applicable, as well as a vehicle.

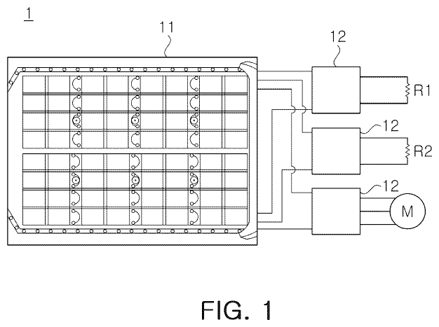

FIG. 1 illustrates an electric vehicle drive system including a general high-voltage battery pack.

Referring to FIG. 1, an electric vehicle drive system 1 may include a general high-voltage battery pack 11 and various power conversion devices 12.

In this case, the general high-voltage battery pack 11 may be configured by a series/parallel combination of a plurality of battery cells, and may not include a separate power conversion device. In addition, the general high-voltage battery pack 11 may output a high voltage (for example, 480 V to 806.4 V) having a single magnitude. In addition, the power conversion device 12 may be provided in a separate space separated from the high-voltage battery pack 11, and the high-voltage battery pack 11 and the power conversion device 12 may be connected by a high-voltage cable.

An electric vehicle may have an electric field load with various functions, and since a magnitude and a type of voltage required for each electric field load may be diverse, various types of power conversion devices 12 may be required. According to the electric vehicle drive system 1 including the general high-voltage battery pack 11, the high-voltage power conversion device 12 should be used because the electric vehicle drive system 1 is based on a single high voltage.

More specifically, the electric vehicle drive system 1 may convert a high voltage output from the general high-voltage battery pack 11 into a DC low voltage, to provide a driving voltage to a low-voltage load R1 or to charge a low-voltage battery. In this case, energy loss may occur in a process of converting power from a high voltage to a low voltage, which may reduce efficiency, and a separate transformer may be additionally required because the voltage should be significantly lowered. In addition, the electric vehicle drive system 1 may convert a voltage output from the general high-voltage battery pack 11, to provide a driving voltage to a high-voltage load R2, and may form a high-voltage three-phase AC power, to provide a driving voltage to a motor M. In this case, a SiC power semiconductor for high-voltage switching may be generally used as an inverter that operate at high voltage, but the SiC power semiconductor may have low yield compared to high demand, making it difficult to supply and request current smoothly, and the relatively high price thereof may increase production costs.

In addition, the electric vehicle drive system 1 may have a separate structure in which the high-voltage battery pack 11 and the power conversion devices are each separated, each component therein may occupy a separate space, and the high-voltage cable should be used to connect them, which may take up a large amount of volume. In addition, the electric vehicle drive system 1 may generate a large amount of heat due to the high-voltage output of the high-voltage battery pack 11, and a water-cooling system may be required to control the heat, which may take up a large amount of volume and be relatively heavy.

In addition, according to the electric vehicle drive system 1, since specifications therefor are different depending on a type of vehicle, the battery system should be individually designed according to the specifications of the type of vehicle, which may complicate a process and increase production costs.

A battery system according to an embodiment of the present disclosure, described below, may be configured by a series/parallel combination of a plurality of battery modules, and each of the battery modules may include a low-voltage battery and a power conversion device such as an inverter, a converter, or the like, operating at a low voltage.

For example, since a battery system according to an embodiment of the present disclosure may be configured based on a battery module, and each battery module may include a power conversion device, the battery system may store/release electrical energy as well as perform power conversion in the battery module. Therefore, a battery module according to an embodiment of the present disclosure may convert direct current power into alternating current power or convert a magnitude of battery power and output the battery power, as required. In addition, output of each battery module may be connected in series to form a high-voltage output or connected in parallel to form a high-current output, and a voltage of each battery module may be monitored to perform balancing control. Hereinafter, a battery module according to an embodiment of the present disclosure and a battery system including the same will be described in more detail.

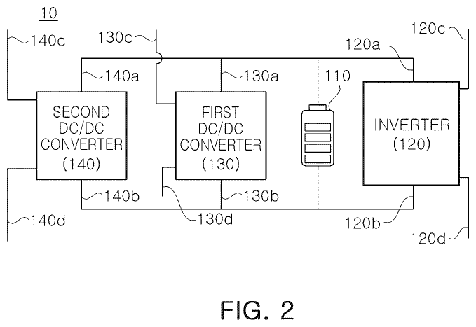

FIG. 2 illustrates a battery module according to an embodiment of the present disclosure.

Referring to FIG. 2, a battery module 10 according to an embodiment of the present disclosure may include a battery 110, an inverter 120, a first DC/DC converter 130, and a second DC/DC converter 140.

The battery 110 may output a battery voltage, and may charge or discharge electrical energy. In addition, the battery voltage may constitute a base voltage of the battery module 10, to provide an input voltage to the inverter 120, the first DC/DC converter 130, and the second DC/DC converter 140.

In addition, the battery 110 may have a battery voltage of a magnitude, lower than a magnitude of the general high-voltage battery pack 11 described in FIG. 1. Therefore, since a battery module 10 for a vehicle according to an embodiment of the present disclosure may apply a power conversion device capable of operating at a low voltage, manufacturing costs may be reduced.

According to a battery module 10 according to an embodiment of the present disclosure, voltages of various magnitudes and types may be output depending on a series/parallel combination of battery modules 10. Therefore, the battery module 10 may be applied to various vehicles of various specifications using a battery module 10 of a single specification, and manufacturing costs may be reduced.

For example, when the battery voltage is set to 100V, a battery system outputting a voltage of 400V may be formed by connecting 4 battery modules 10 in series, and a battery system outputting a voltage of 800V may be formed by combining 8 battery modules 10 in series. In addition, for example, when the battery voltage is set to 50V, a battery system outputting a voltage of 400V may be formed by connecting 8 battery modules 10 in series, and a battery system outputting a voltage of 800V may be formed by connecting 16 battery modules 10 in series.

In addition, a single-phase battery system outputting a high-voltage AC voltage may be configured by connecting battery modules 10 in series and using an inverter output, and a three-phase AC voltage may be output by using a plurality of single-phase battery systems. In addition, a battery system in which a high current flows may be formed by combining battery modules 10 in parallel.

The inverter 120 may convert the battery voltage into an AC module voltage, and may output the AC module voltage. In addition, the inverter 120 may include an input terminal and an output terminal, and the inverter input terminal may be connected to the battery in parallel, to receive the battery voltage, and the inverter output terminal may output the AC module voltage. In addition, the inverter output terminal may be referred to as an AC module output terminal outputting the AC module voltage hereinafter. In addition, the inverter 120 may be configured to supply AC power according to the AC module voltage to an AC load. In this case, the AC load may be a load such as a motor or the like using the AC voltage as a driving voltage.

In addition, the first DC/DC converter 130 may convert the battery voltage into a first DC module voltage, lower than the battery voltage, and may output the first DC module voltage.

The first DC module voltage may be set as a driving voltage of a low-voltage load. For example, the low-voltage load may be an electric field load such as various lamps, radios, and infotainment systems of an electric vehicle. The first DC module voltage may be set as a driving voltage of a low-voltage load such as 12 V, 24 V, 48 V, or the like. A magnitude of the voltage mentioned in this specification may be only an embodiment, and may be set to a voltage of various magnitudes depending on a design.

The first DC/DC converter may include input terminals 130a and 130b and output terminals 130c and 130d, and the input terminals 130a and 130b of the first DC/DC converter may be connected to the battery in parallel, to receive the battery voltage, and the output terminals 130c and 130d of the first DC/DC converter may output the first DC module voltage. Hereinafter, the output terminals 130c and 130d of the first DC/DC converter may also be referred to as a first DC module output terminal outputting the first DC module voltage.

In addition, the output terminals 130c and 130d of the first DC/DC converter may be directly connected to the low-voltage load to provide the first DC module voltage.

In an embodiment, one end (130d) of the output terminal of the first DC/DC converter may be grounded, and the other end 130c may be connected to the low-voltage load to output the first DC module voltage. In another embodiment, both ends of the output terminal of the first DC/DC converter may be connected to both ends of the low-voltage load to output the first DC module voltage.

The second DC/DC converter 140 may convert the battery voltage into a second DC module voltage, and may output the second DC module voltage. The second DC module voltage may be set to a value, greater than the first DC module voltage output from the first DC/DC converter 130. The second DC module voltage may be smaller than or equal to the battery voltage, and may be greater than the battery voltage.

In addition, the second DC module voltage output from the second DC/DC converter 140 may be connected in series with a second DC module voltage output from a different battery module 10, to provide power to a high-voltage load. For example, the second DC module voltage output from the second DC/DC converter 140 may not provide power to the high-voltage load as a single output, but may be connected in series with a second DC module voltage of a different battery module 10, to provide power to a high-voltage load. Since the battery voltage included in the battery module 10 may be configured as a low voltage, a plurality of battery modules 10 may be combined in series to provide a high voltage, to provide a voltage to the high-voltage load such as an air conditioning system or the like. For example, the output terminal of the second DC/DC converter may be connected in series with an output terminal of the second DC/DC converter of another battery module, to form a high voltage, and may provide power to the high-voltage load.

In addition, the second DC/DC converter may include input terminals 140a and 140b and output terminals 140c and 140d, and the input terminals 140a and 140b of the second DC/DC converter may be connected to the battery in parallel 110, to receive the battery voltage, and the output terminals 140c and 140d of the second DC/DC converter may output the second DC module voltage. In addition, the output terminals 140c and 140d of the second DC/DC converter in this specification may also be referred to as a second DC module output terminal outputting the second DC module voltage.

In addition, the output terminals 140c and 140d of the second DC/DC converter may be connected in series with an output terminal of a second DC/DC converter included in a different battery module, or may be connected to the high-voltage load. In this case, a specific connection structure with the different battery module 10 will be described later. The battery 110 may be configured to be connected in parallel with input terminals 120a and 120b of the inverter, the input terminals 130a and 130b of the first DC/DC converter, and the input terminals 140a and 140b of the second DC/DC converter.

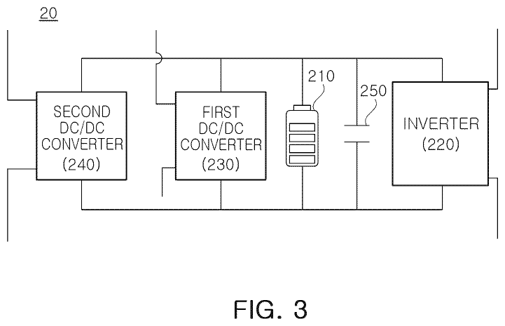

FIG. 3 illustrates a battery module according to an embodiment of the present disclosure.

Referring to FIG. 3, a battery module 20 according to an embodiment of the present disclosure may include a battery 210, an inverter 220, a first DC/DC converter 230, a second DC/DC converter 240, and a common capacitor 250. The common capacitor 250 may be connected to the battery in parallel 210. The battery module 20 illustrated in FIG. 3 may include all the configurations of the battery module 10 illustrated in FIG. 2, and may further include the common capacitor 250.

According to a battery module 20 according to an embodiment of the present disclosure, since one common capacitor may be shared without applying individual capacitors to each inverter and converter device, a volume may be reduced, and since a low-voltage capacitor may be applied, production costs may be reduced.

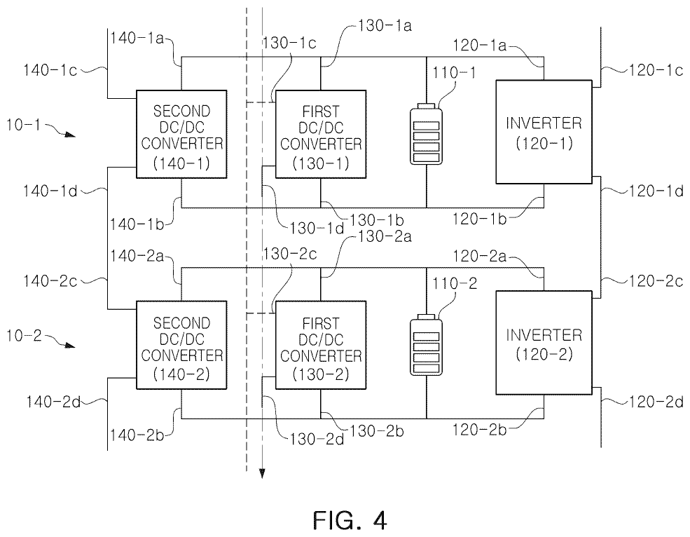

FIG. 4 is a view illustrating a connection structure between a plurality of battery modules according to an embodiment of the present disclosure.

Referring to FIG. 4, a first battery module 10-1 and a second battery module 10-2 may include the same configuration, and may be configured to have the same structure. In addition, as described with reference to FIG. 2, the first battery module 10-1 and the second battery module 10-2 may include a battery (110-1 and 110-2), an inverter (120-1 and 120-2), a first DC/DC converter (130-1 and 130-2), and a second DC/DC converter (140-1 and 140-2), respectively. Alternatively, as described with reference to FIG. 3, the first battery module 10-1 and the second battery module 10-2 may further include a common capacitor.

In addition, a plurality of battery modules may be connected to configure a battery system, and a connection relationship between the plurality of battery modules included in the battery system may be the same as the structure illustrated in FIG. 4.

More specifically, output terminals 120-1c and 120-1d of the inverter included in the first battery module 10-1 may be connected in series with output terminals 120-2c and 120-2d of the inverter included in the second battery module 10-2. When the inverter outputs an AC module voltage, the inverter 120-1 included in the first battery module and the inverter 120-2 included in the second battery module may be connected in series to output the AC module voltage twice in magnitude. For example, when the AC module voltage is set to 100 V, the two inverters 120-1 and 120-2 connected in series may output an AC voltage of 200 V. In this case, a magnitude of the AC voltage may mean a maximum value, an effective value, or an average value of AC voltages.

Output terminals 130-1c and 130-1d of the first DC/DC converter included in the first battery module 10-1 and output terminals 130-2c and 130-2d of the first DC/DC converter included in the second battery module 10-2 may be connected in parallel. In an embodiment, one end (130-1d) of the first DC/DC converter included in the first battery module 10-1 may be grounded, and one end (130-2d) of the output terminal of the first DC/DC converter included in the second battery module 10-2 may be grounded. The other end (130-1c) of the output terminal of the first DC/DC converter included in the first battery module 10-1 and the other end (130-2c) of the output terminal of the first DC/DC converter included in the second battery module 10-2 may be connected in parallel to output a first DC module voltage. The output terminals of the other ends of the output terminals of the first DC/DC converter may be connected in parallel to output the first DC module voltage, and may be connected to a low-voltage load using the first DC module voltage as a driving voltage, to provide a voltage.

In addition, output terminals 140-1c and 140-1d of the second DC/DC converter included in the first battery module 10-1 may be connected in series with output terminals 140-2c and 140-2d of the second DC/DC converter included in the second battery module 10-2. More specifically, one end (140-1d) of the output terminal of the second DC/DC converter included in the first battery module 10-1 may be connected to the other end (140-2c) of the output terminal of the second DC/DC converter of the second battery module 10-2.

When the second DC/DC converter outputs a second DC module voltage, the second DC/DC converter 140-1 included in the first battery module and the second DC/DC converter 140-2 included in the second battery module may be connected in series to output the second DC module voltage twice in magnitude. For example, when the second DC module voltage is set to 100 V, the two second DC/DC converters 140-1 and 140-2 connected in series may output 200 V.

To summarize, in the first battery module 10-1 and the second battery module 10-2, the inverters may be connected in series, the first DC/DC converters may be connected in parallel, and the second DC/DC converters may be connected in series.

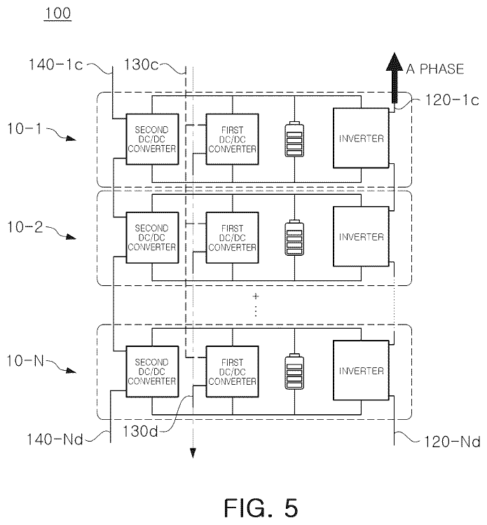

FIG. 5 illustrates a single-phase battery system according to an embodiment of the present disclosure.

Referring to FIG. 5, a single-phase battery system 100 according to an embodiment of the present disclosure may include a plurality of battery modules 10-1, 10-2, . . . , and 10-N. Each of the plurality of battery modules 10-1, 10-2, . . . , 10-N included in the single-phase battery system 100 may be identical to the battery modules 10 and 20 illustrated in FIG. 2 or FIG. 3. In addition, the plurality of battery modules 10-1, 10-2, . . . , 10-N included in the single-phase battery system 100 may have a connection structure between the battery modules illustrated in FIG. 4.

Referring again to FIG. 3, a battery module according to an embodiment of the present disclosure may include first DC module output terminals 130c and 130d corresponding to the output terminal of the first DC/DC converter, second DC module output terminals 140c and 140d corresponding to the output terminal of the second DC/DC converter, and AC module output terminals 120c and 120d corresponding to the output terminal of the inverter.

Referring to FIG. 5, a single-phase battery system 100 according to an embodiment of the present disclosure may include first DC system output terminals 130c and 130d configured by connecting first DC module output terminals, included in each of the plurality of battery modules, in parallel. In this case, the first DC system output terminals 130c and 130d may output a first DC system voltage, and the first DC system voltage may have the same magnitude as a first DC module voltage output from an output terminal of a first DC/DC converter.

A single-phase battery system 100 according to an embodiment of the present disclosure may include second DC system output terminals 140-1c and 140-Nd configured by connecting second DC module output terminals, included in each of the plurality of battery modules, in series. In this case, the second DC system output terminals 140-1c and 140-Nd may output a second DC system voltage, and the second DC system voltage may have a magnitude that may be an integer (N) times a second DC module voltage output from an output terminal of a second DC/DC converter.

In addition, a single-phase battery system 100 according to an embodiment of the present disclosure may include AC system output terminals 120-1c and 120-Nd configured by connecting AC module output terminals, included in each of the plurality of battery modules, in series. In addition, the AC system output terminals 120-1c and 120-Nd may output an AC system voltage, and the AC system voltage may have a magnitude that may be an integer (N) times an AC module voltage output from an output terminal of a inverter. The AC system output terminals may provide an AC power to an AC load, and may provide an input voltage for one phase of a three-phase AC voltage.

In summary, the single-phase battery system 100 may provide various output voltages including the first DC system voltage, the second DC system voltage, and the AC system voltage by connecting each device of the plurality of battery modules in series or in parallel.

An electric vehicle may include a low-voltage load R1 operating at a low voltage, a high-voltage load R2 operating at a high voltage, and an AC load such as a motor M or the like operating at a high-voltage three-phase AC voltage. In addition, the low-voltage load may use the first DC system voltage as a driving voltage, the high-voltage load may use the second DC system voltage as a driving voltage, and the AC load may use the AC system voltage as a driving voltage.

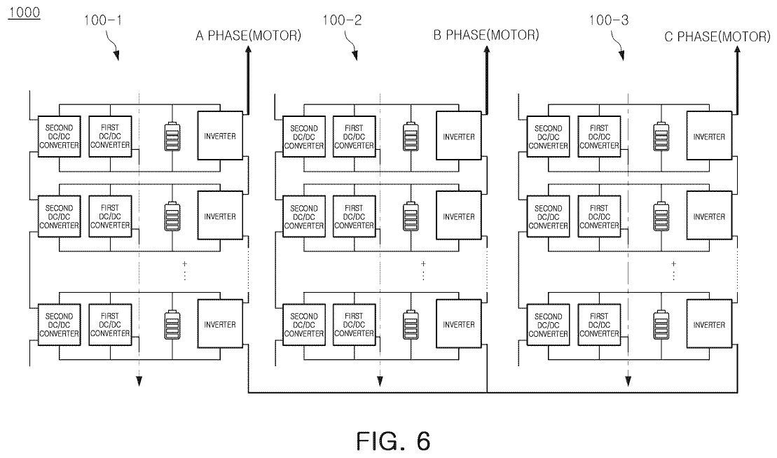

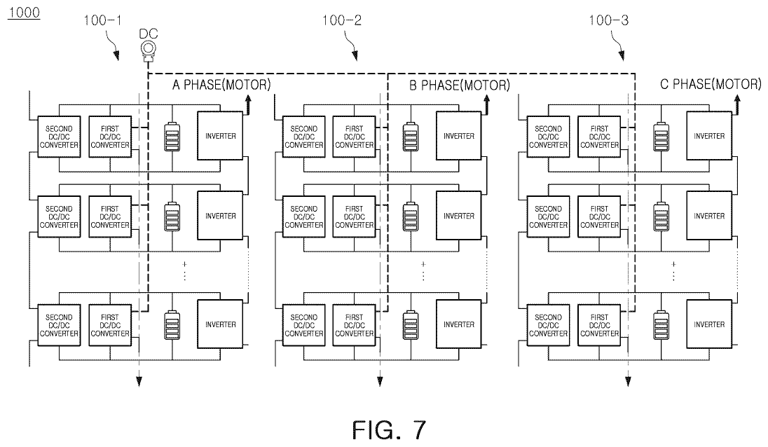

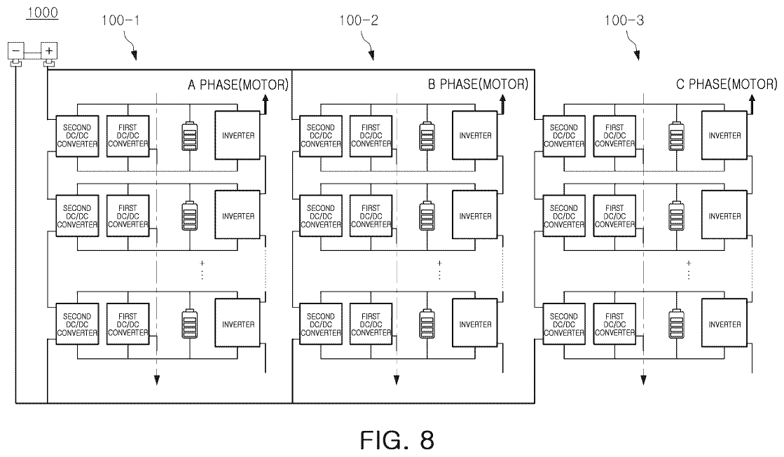

FIG. 6 is a view illustrating a connection relationship of an inverter in a three-phase battery system 1000 according to an embodiment of the present disclosure. FIG. 7 is a view illustrating a connection relationship of a first DC/DC converter in a three-phase battery system according to an embodiment of the present disclosure. In addition, FIG. 8 is a view illustrating a connection relationship of a second DC/DC converter in a three-phase battery system according to an embodiment of the present disclosure.

Referring to FIGS. 6 to 8, a three-phase battery system 1000 according to an embodiment of the present disclosure may include a plurality of single-phase battery systems 100-1, 100-2, and 100-3, and each of the single-phase battery systems may include a plurality of battery modules.

Referring to FIG. 6, a three-phase battery system 1000 according to an embodiment of the present disclosure may include three single-phase battery systems 100-1, 100-2, and 100-3. In addition, the single-phase battery systems may include AC system output terminals configured by connecting inverter output terminals in series. In addition, each of the AC system output terminals included in the three single-phase battery systems may output different AC voltages having the same magnitude and the same phase difference.

For example, each of the AC system output terminals included in the three single-phase battery systems may output different AC voltages having a phase difference of 120 degrees from each other. Therefore, the three-phase battery system may output a three-phase AC voltage, and may provide a driving voltage to a motor using the three-phase AC voltage as a driving voltage.

Referring to FIG. 7, each of a plurality of single-phase battery systems 100-1, 100-2, and 100-3 included in a three-phase battery system 1000 according to an embodiment of the present disclosure may include a first DC system output terminal in which a plurality of first DC/DC converters are connected to each other in parallel to output a first DC system voltage. First DC system output terminals included in each of the plurality of single-phase battery systems 100 may be connected to each other in parallel.

For example, when the single-phase battery system 100 includes N first DC/DC converters, all 3*N first DC/DC converters included in the three-phase battery system 1000 may be connected in parallel to output a first DC module voltage or a first DC system voltage having the same magnitude as the first DC module voltage.

In addition, referring to FIG. 8, each of a plurality of single-phase battery systems 100 included in a three-phase battery system 1000 according to an embodiment of the present disclosure may include a second DC system output terminal in which a plurality of second DC/DC converters are connected in series to each other to output a second DC system voltage. In addition, second DC system output terminals included in each of the plurality of single-phase battery systems may be connected in parallel to each other. For example, in the single-phase battery systems 100, the second DC module output terminals may be connected in series to form the second DC system output terminal, and in the three-phase battery system 1000, each of the plurality of second DC system output terminals may be connected in parallel to each other.

In addition, the three-phase battery system may further include a controller (not illustrated). The controller may individually control each of the battery modules, and may individually control the inverter, the first DC/DC converter, and the second DC/DC converters included in each of the battery modules. Therefore, according to an embodiment of the present disclosure, energy efficiency may increase by performing balancing control for each power conversion device and each battery module.

In addition, when a problem occurs in a portion of the N battery modules, the controller may block only a battery module in which the problem occurs, to secure reliability of the overall system.

In addition, since the controller may individually control each battery module, even when deterioration occurs differently for each battery module, deterioration performance of each battery module may be actively controlled.

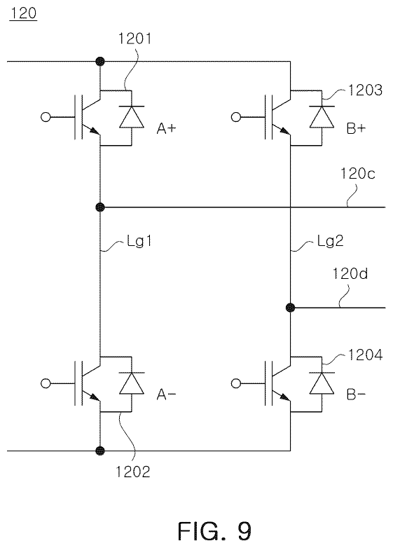

FIG. 9 is a view illustrating an inverter structure according to an embodiment of the present disclosure.

Referring to FIG. 9, an inverter 120 may include a plurality of Si-metal oxide semiconductor field effect transistor (Si-MOSFET) devices 1201, 1202, 1203, and 1204, and may be configured as an H-bridge single-phase inverter structure.

In conventional electric vehicle systems, SiC power semiconductors may be mainly applied. Such SiC power semiconductors may have high efficiency and fast switching speed, but may be expensive.

In addition, the conventional electric vehicle systems may sometimes use insulated gate bipolar transistors (IGBTs) at low voltages, and the IGBTs may be relatively inexpensive, but may have slow switching speeds.

The Si-MOSFET devices may have fast switching speeds, and may be relatively inexpensive, but performance thereof may deteriorate at high voltages, making them difficult to apply to the conventional high-voltage electric vehicle systems.

Since a battery module according to an embodiment of the present disclosure is driven at a low voltage, the Si-MOSFET devices may be applied to the inverter. Therefore, an inverter included in a battery module according to an embodiment of the present disclosure may use a plurality of Si-MOSFET devices, to reduce production costs while having a fast switching speed. Therefore, power efficiency may be improved to increase a vehicle driving range, and as the driving range increases, battery capacity may be reduced to decrease production costs.

In addition, an inverter according to an embodiment of the present disclosure may be configured as an H-bridge single-phase inverter structure to maintain stability even at a large amount of current.

In addition, although FIG. 9 illustrates a case in which an H-bridge circuit is configured using four Si-MOSFETs as an example, it is also possible to configure the H-bridge circuit by connecting a plurality of Si-MOSFETs in parallel to switch a large amount of current.

In addition, according to an embodiment of the present disclosure, a battery system may include a plurality of battery modules and a controller. In addition, the controller may perform balancing control on each of the plurality of battery modules to maintain a state-of-charge (SoC) or a voltage of a battery included in each of the plurality of battery modules within a certain deviation.

More specifically, a battery system according to an embodiment of the present disclosure may perform balancing control of the battery module by controlling on/off switching of a first DC/DC converter included in the battery module. As described above, the first DC/DC converter may be a power conversion device supplying a first DC module voltage to a low-voltage load for a vehicle. In addition, although first DC/DC converters included in each of the plurality of battery modules are all connected in parallel, to turn off one thereof and not to supply power to the low-voltage load, the first DC module voltage may be provided to the low-voltage load by a remaining first DC/DC converter, turned on.

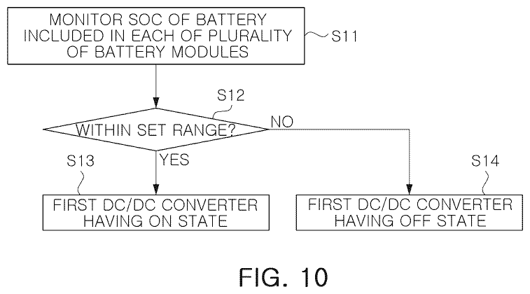

FIG. 10 is a flowchart of a balancing control method of a battery module according to an embodiment of the present disclosure.

Referring to FIG. 10, a controller may monitor a SoC or a battery voltage of a battery included in each of a plurality of battery modules (S11).

The controller may determine whether the SoC or the battery voltage of the battery is within a set range (S12). In this case, the set range may have a value, smaller than a reference value, by a certain value. The reference value may be an average value, a median value, or an average value of the highest and lowest values of the SoC or the battery voltage of the battery included in each of the plurality of battery modules. The reference value may not be a fixed value, but may be changed over time, and may be a value decreasing according to usage of a battery system. In an embodiment, the reference value may be set to have 1% to 2%.

When the controller determines that the SoC or the battery voltage of the battery is within the set range, the controller may control a first DC/DC converter included in a battery module corresponding thereto to have an ON state (S13). In addition, when the controller determines that the SoC or the battery voltage of the battery is outside the set range, the controller may control a first DC/DC converter included in a battery module corresponding thereto to have an OFF state (S14).

For example, when a SoC average value of the plurality of battery modules is 70% and the certain value is set to have 1%, the first DC/DC converter of the battery module having SoC, smaller than 69%, may be controlled to have the OFF state, and the first DC/DC converter of the battery module having the SoC greater than 69% may be controlled to have the ON state.

Alternatively, when the SoC average value of the plurality of battery modules is 70% and the certain value is set to have 2%, the first DC/DC converter of the battery module having SoC, smaller than 68%, may be controlled to have the OFF state, and the first DC/DC converter of the battery module having SoC, greater than 68%, may be controlled to have the ON state.

For example, a battery system may include 24 battery modules, of which 22 battery modules may have a SoC of 75% and 2 battery modules may have a SoC of 70%. Then, a first DC/DC converter of the two battery modules having a SoC of 70% may be controlled to have the OFF state, and a first DC/DC converter of the 22 battery modules having a SoC of 75% may be controlled to have the ON state. Then, as time passes, the two battery modules having a SoC of 70% may consume less power than different battery modules, to reduce SoC deviation between the battery modules. Thereafter, the controller may continuously monitor the SoC or the battery voltage of the battery, and when the SoC of the battery module falls within the set range, e.g., when the SoC of the battery module is a value, smaller than a reference value, by a certain value, the first DC/DC converter may be converted to have the ON state.

In addition, when the first DC/DC converter is in the ON state, the first DC/DC converter may convert the battery voltage into a first DC module voltage, smaller than the battery voltage, and may provide the first DC module voltage to a low-voltage load for a vehicle.

When the first DC/DC converter is in the OFF state, the first DC/DC converter may not convert the battery voltage, and may not provide power to the low-voltage load for the vehicle. Therefore, when the first DC/DC converter is in the OFF state, consumption of the battery SoC may be smaller than when the first DC/DC converter is in the ON state.

By doing so, the controller may reduce SoC deviation between the battery modules, and may perform balancing control at a certain level by supplying power to the low-voltage load for the vehicle only from battery modules having a battery voltage or a SoC, greater than the set value.

In addition, the controller may be configured to perform a balancing control method for a battery module, as described above.

The controller may set the maximum number of the first DC/DC converters in the OFF state. When the number of the first DC/DC converters in the OFF state is not set, the number of the first DC/DC converters in the OFF state may increase excessively, and low-voltage power may not be smoothly supplied to the low-voltage load. Therefore, the controller may smoothly supply power to the low-voltage load by setting the maximum number of the first DC/DC converters in the OFF state or the minimum number of the first DC/DC converters in the ON state. In an embodiment, the maximum number of the first DC/DC converters in the OFF state or the minimum number of the first DC/DC converters in the ON state may be set based on the number of low-voltage loads requiring power. For example, it may be set that the more low-voltage loads that require power, the smaller the maximum number of first DC/DC converters in the OFF state. Alternatively, it may be set that the smaller the low-voltage loads that require power, the larger the maximum number of first DC/DC converters in the OFF state.

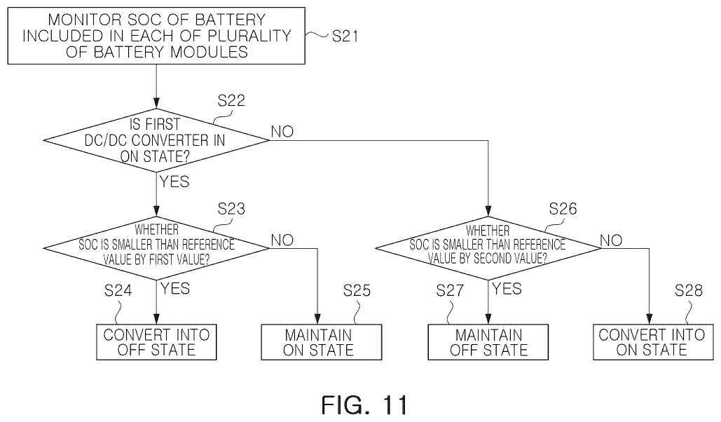

FIG. 11 is a flowchart of a balancing control method of a battery module according to an embodiment of the present disclosure.

Referring to FIG. 11, a controller may monitor a battery state including at least one of a SoC or a battery voltage of a battery included in each of a plurality of battery modules (S21). Then, the controller may determine whether a first DC/DC converter included in each of the plurality of battery modules may be in an ON state (S22).

When the first DC/DC converter is in the ON state, the controller may determine whether the SoC of the battery module is smaller than a reference value by a first value (S23). In this case, the reference value may be an average value, a median value, or an average value of the highest and lowest values of the SoC or the battery voltage of the battery included in each of the plurality of battery modules. In an embodiment, the first value may be an error range of the reference value, and may be set to have 1% to 2%.

When the first DC/DC converter is in the ON state and the SoC of the battery module is smaller than the reference value by the first value, the controller may convert the first DC/DC converter of the ON state into an OFF state (S24). In addition, when the SoC of the battery module is not smaller than the reference value by the first value, the controller may maintain the first DC/DC converter in the ON state (S25).

When the first DC/DC converter is in the OFF state, the controller may determine whether the SoC of the battery module is smaller than the reference value by a second value (S26). In this case, the second value may be a value, smaller than the first value. The reference value may be an average value, a median value, or an average value of the highest and lowest values of the SoC or the battery voltage of the battery included in each of the plurality of battery modules. In an embodiment, the second value may be set to have 1% to 2%.

When the first DC/DC converter is in the OFF state and the SoC of the battery module is smaller than the reference value by the second value, the controller may maintain the first DC/DC converter in the OFF state (S27). When the first DC/DC converter is in the OFF state and the SoC of the battery module is not smaller than the reference value by the second value, the controller may convert the first DC/DC converter into the ON state (S28).

In an embodiment, the first value may be set to have 2%. When a SoC average value of the battery is 70%, and a SoC value of the battery module including the first DC/DC converter in the ON state falls 68% or less, the controller may convert the first DC/DC converter into the OFF state. When the SoC value of the battery module including the first DC/DC converter in the ON state does not fall 68% or less, the controller may maintain the first DC/DC converter in the ON state.

The second value may be set to have 1%. When a SoC of the battery module including the first DC/DC converter in the OFF state is smaller than 1% than the reference value, the first DC/DC converter may maintain the OFF state. When the SoC of the battery module including the first DC/DC converter in the OFF state is not smaller than 1% than the reference value, the controller may convert the first DC/DC converter into the ON state.

For example, to convert the first DC/DC converter from the ON state to the OFF state, the controller may determine whether the SoC is smaller than the reference value by the first value. To convert the first DC/DC converter from the OFF state to the ON state, the controller may determine whether the SoC is smaller than the reference value by the second value.

When the first value and the second value is set to be equal to each other, and the SoC of the battery oscillates near the reference value, on/off switching of the first DC/DC converter may be frequently converted, which may result in unnecessary power consumption.

Therefore, the controller may set a criterion for converting from the ON state to the OFF state to be lower than a case of converting from the OFF state to the ON state, to maintain the ON state for a long time. The controller may set the criterion for converting from the OFF state to the ON state to be higher or more generous than the case of converting from the ON state to the OFF state, to maintain the OFF state for a long time.

In addition, the controller may be configured to perform a balancing control method for a battery module, as described above.

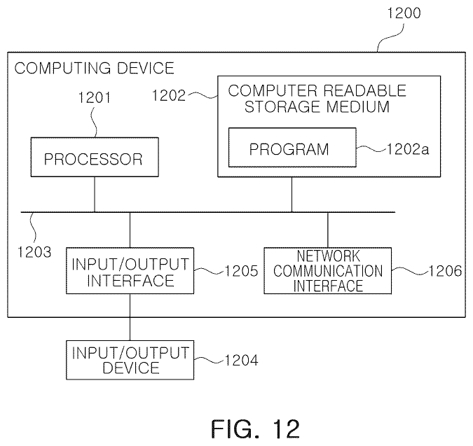

FIG. 12 is a block diagram of a computing device that may fully or partially implement a battery module balancing control system according to an embodiment of the present disclosure.

As illustrated in FIG. 12, a computing device 1200 may include at least one processor 1201, a computer-readable storage medium 1202, and a communication bus 1203.

The processor 1201 may cause the computing device 1200 to operate according to the example embodiment mentioned above. For example, the processor 1201 may execute one or more programs stored in the computer-readable storage medium 1202. The one or more programs may include one or more computer-executable instructions, and the computer-executable instructions may be configured to cause the computing device 1200 to perform operations according to the example embodiment when executed by the processor 1201. The processor 1201 described above may implement a controller, as described above.

The computer-readable storage medium 1202 may be configured to store the computer-executable instructions or a program code, a program data, and/or other suitable forms of information. A program 1202a stored on the computer-readable storage medium 1202 may include a set of instructions executable by the processor 1201. In an embodiment, the computer-readable storage medium 1202 may be memory (volatile memory, such as random access memory, non-volatile memory, or a suitable combination thereof), one or more magnetic disk storage devices, one or more optical disk storage devices, one or more flash memory devices, or any other form of storage medium that may be accessed by the computing device 1200 and may store desired information, or a suitable combination thereof.

The communication bus 1203 may include the processor 1201 and the computer-readable storage medium 1202, to interconnect other various components of the computing device 1200.

The computing device 1200 may also include one or more input/output interfaces 1205 and one or more network communication interfaces 1206, which provide interfaces for one or more input/output devices 1204. The input/output interfaces 1205 and the network communication interfaces 1206 may be connected to the communication bus 1203. The input/output devices 1204 may be connected to other components of the computing device 1200 via the input/output interfaces 1205. The illustrative input/output devices 1204 may include an input device such as a pointing device (mouse, trackpad, or the like), a keyboard, a touch input device (touchpad, touchscreen, or the like), a voice input device, a sound input device, various types of sensor devices, and/or a photographing device, and/or an output device such as a display device, a printer, a speaker, and/or a network card. The illustrative input/output device 1204 may be included in the computing device 1200 as a component constituting the computing device 1200, or may be connected to the computing device 1200 as a separate device distinguished from the computing device 1200.

An embodiment of the present disclosure may include a program for performing the methods described in this specification on a computer, and a computer-readable recording medium including the program. The computer-readable recording medium may include a program command, a local data file, a local data structure, or the like, alone or in combination. The medium may be those designed and configured specifically for the present disclosure, or may be those commonly available in the computer software field. Examples of the computer-readable recording medium may include a magnetic media such as a hard disk, a floppy disk, and a magnetic tape, an optical recording media such as a CD-ROM and a DVD, and a hardware device specifically configured to store and perform a program command such as a ROM, a RAM, a flash memory, or the like. The above program examples may include not only a machine language code such as those generated by a compiler, but also a high-level language code that may be executed by a computer using an interpreter, or the like.

Although representative embodiments of the present disclosure have been described in detail above, those skilled in the art will understand that various modifications may be made to the above-described embodiments without departing from the scope of the present disclosure. Therefore, the scope of the rights of the present disclosure should not be limited to the described embodiments, but should be defined not only by the claims described below but also by equivalents thereof.

According to an embodiment of the present disclosure, by performing balancing control of maintaining deviation of SoC between a plurality of battery modules configured by a series/parallel combination of the plurality of battery modules operating at a low voltage within a certain range, to decrease a battery charging time and increase a driving time or a distance.

In addition, according to an embodiment of the present disclosure, by controlling on/off switching of a converter included in each battery module in a controller, active balancing control may be performed for balancing control.

While example embodiments have been illustrated and described above, it will be apparent to those skilled in the art that modifications and variations could be made without departing from the scope of the present disclosure as defined by the appended claims.

1. A balancing control system for a battery module, comprising:
a plurality of battery modules each including a battery outputting a battery voltage, a first DC/DC converter connected to the battery in parallel, and an inverter converting the battery voltage into an AC module voltage and outputting the battery voltage; and
a controller configured to control each of the plurality of battery modules;
wherein first DC/DC converters included in the plurality of battery modules are connected to each other in parallel; and
wherein the controller is configured to monitor a battery state including at least one of a state-of-charge (SoC) of the battery or the battery voltage, and to control the first DC/DC converter to have an ON state or an OFF state based on the battery state.

2. The balancing control system of claim 1, wherein the controller is configured to:
determine whether the battery state is within a set range;
when the battery state is within the set range, control the first DC/DC converter to have the ON state; and
when the battery state is outside the set range, control the first DC/DC converter to have the OFF state.

3. The balancing control system of claim 2, wherein the set range is set to have a value, smaller than a reference value, by a certain value.

4. The balancing control system of claim 1, wherein the controller is further configured to:
determine whether the first DC/DC converter is in the ON state;
when the first DC/DC converter is in the ON state, determine whether the battery state is smaller than a reference value by a first value;
when the battery state is smaller than the reference value by the first value, convert the ON state of the first DC/DC converter to the OFF state; and
when the battery state is not smaller than the reference value by the first value, maintain the first DC/DC converter in the ON state.

5. The balancing control system of claim 4, wherein the controller is further configured to:
determine whether the first DC/DC converter is in the ON state;
when the first DC/DC converter is in the OFF state, determine whether the battery state is smaller than the reference value by a second value;
when the battery state is smaller than the reference value by the second value, maintain the first DC/DC converter in the OFF state; and
when the battery state is not smaller than the reference value by the second value, convert the OFF state of the first DC/DC converter to the ON state.

6. The balancing control system of claim 5, wherein the second value is smaller than the first value.

7. The balancing control system of claim 3, wherein the reference value is set to an average value, a median value, or an average value of a highest value and a lowest value of battery states of the plurality of battery modules.

8. The balancing control system of claim 1, wherein the first DC/DC converter is set to convert the battery voltage into a first DC module voltage in the ON state and provide the first DC module voltage to low-voltage load for a vehicle.

9. The balancing control system of claim 1, wherein each of the plurality of battery modules further comprises a second DC/DC converter converting the battery voltage into a second DC module voltage and outputting the second DC module voltage.

10. The balancing control system of claim 9, wherein second DC/DC converters included in the plurality of battery modules are connected in series with each other.

11. The balancing control system of claim 1, wherein inverters included in the plurality of battery modules are connected in series with each other.

12. A balancing control method for a plurality of battery modules each including a battery, a first DC/DC converter connected to the battery in parallel, and an inverter, the method comprising:
monitoring, by a controller, a battery state including at least one of a state-of-charge (SoC) of the battery included in each of the plurality of battery modules, or a battery voltage; and
controlling the first DC/DC converter to have an ON state or an OFF state based on the battery state.

13. The balancing control method of claim 12, wherein controlling the first DC/DC converter to an ON state or an OFF state, comprises:
determining whether the battery state is within a set range;
when the battery state is within the set range, controlling the first DC/DC converter to have the ON state; and
when the battery state is outside the set range, controlling the first DC/DC converter to have the OFF state.

14. The balancing control method of claim 12, wherein controlling the first DC/DC converter to an ON state or an OFF state, comprises:
determining whether the first DC/DC converter is in the ON state;
when the first DC/DC converter is in the ON state, determining whether the battery state is smaller than a reference value by a first value;
when the battery state is smaller than the reference value by the first value, converting the ON state of the first DC/DC converter to the OFF state; and
when the battery state is not smaller than the reference value by the first value, maintaining the first DC/DC converter in the ON state.

15. The balancing control method of claim 14, wherein controlling the first DC/DC converter to have an ON state or an OFF state, comprises:
determining whether the first DC/DC converter is in the ON state;
when the first DC/DC converter is in the OFF state, determining whether the battery state is smaller than the reference value by a second value;
when the battery state is smaller than the reference value by the second value, maintaining the first DC/DC converter in the OFF state; and
when the battery state is not smaller than the reference value by the second value, converting the OFF state of the first DC/DC converter to the ON state.
